(19) United States
(12) Patent Application Publication
(10) Pub. No.: US 2006/0250109 A1
(43) Pub. Date: Nov. 9, 2006

(54) Classification and collection method and identification method for batteries

(76) Inventors: Kazunori Haraguchi, Osaka (JP); Fumio Daio, Osaka (JP)

Correspondence Address: MCDERMOTT WILL & EMERY LLP, 600 13TH STREET, N.W., WASHINGTON, DC, 20005-3096, US

(21) Appl. No.: 11/398,759

(22) Filed: Apr. 6, 2006

(30) Foreign Application Priority Data
Apr. 8, 2005 (JP) 2005-112330

(51) Int. Cl. H02J 7/00

(52) U.S. Cl. 320/110

(57) ABSTRACT

Identifying batteries with restrictions on their transport and handling is properly achieved by mounting an IC tag on the batteries, recording information such as battery types and materials used to the IC tag, and then reading the recorded necessary information from the IC tag. When batteries are spent, recorded information is read from the IC tags of the spent batteries, and then the batteries are classified by type and material used. Then, required discard processing or recycle processing for each classified battery is performed.

The present disclosure relates to subject matter contained in priority Japanese Patent Application No. 2005-112330, filed on Apr. 8, 2005, the contents of which is herein expressly incorporated by reference in its entirety.

### BACKGROUND OF THE INVENTION

1. Field of the Invention

The present invention relates to an identification method for batteries to identify batteries that use materials with restrictions on their transport and handling. The present invention also relates to a classification and collection method for batteries that makes it possible to classify spent batteries into batteries that will undergo resource recovery, batteries specified by a processing method, and other batteries, and then switch to a predetermined process corresponding to each classification.

2. Description of the Related Art

There are many types of batteries and various types are in use from primary batteries such as dry cell batteries to rechargeable batteries. Collecting and recycling these batteries when they are spent is important to control the occurrence of waste and effectively utilize resources. Because primary batteries, such as dry cell batteries, do not use substances harmful to the environment such as mercury, they can be processed as ordinary waste. However, since economic and efficient recycling technologies are not yet established at present, many are processed as non-industrial waste.

The natural resource effective utilization promotion law obliges us to collect and recycle rechargeable batteries. Small rechargeable batteries (targeted for collection and recycling) include nickel-cadmium rechargeable batteries, nickel metal hydride rechargeable batteries, lithium rechargeable batteries, and small sealed lead-acid rechargeable batteries. Many of these small rechargeable batteries are incorporated into devices in the form of battery packs, battery units, and board level packaged batteries. Here, examples of the devices include household products and business machines, communication devices, and disaster prevention equipment. These batteries are removed as spent batteries when repairing, maintaining, and discarding the devices. When nickel metal hydride rechargeable batteries (compatible with dry cell batteries) are spent, they are also disposed of using the same route as dry cell batteries. This makes it necessary to classify them from among dry cell batteries.

Collected small rechargeable batteries are batteries that contain toxic substances such as cadmium or lead and are also batteries that contain trace metals such as cobalt and lithium or noble (precious) metals such as gold or platinum. Recycling of useful metals along with reliable collection and appropriate processing of toxic substances are necessary for these small rechargeable batteries. A classification and collection route for batteries is not yet established and there are actually many ways various types of batteries are mixed together and collected. From a state in which various types of batteries are mixed together, the information necessary for the classification of individual batteries must be recorded in order to classify the batteries by type, material used, and composition. For example, lithium rechargeable batteries basically use lithium as the active material and various material types exist such as cobalt family and manganese family.

There are also batteries that use materials containing corrosive substances in the electrolyte as well as batteries that use combustible materials. Safety while transporting batteries must be taken into consideration and there are regulations on batteries that are applicable to a list of dangerous materials based on United Nations recommendations. Widely used products that have their safety verified during ordinary handling are exempt from transportation regulations when stipulated conditions are satisfied. Although this is the case, the battery to be transported must be identified as a regulated battery and the stipulated conditions must be verified as being satisfied. In addition, the EU is moving towards prohibiting the sale of six toxic substances within the EU according to the environmental regulation “RoHS Directive” required for electric and electronic products. Batteries that contain cadmium and mercury are also regulated. Because of this, there must be an indication that no toxic substances are contained within the composition of the batteries.

Data indicated by bar codes and identification patterns on the exterior surface of batteries is known as information for classifying and collecting batteries or methods to record information for identifying batteries (Japanese Patent Publication No. 11-031485). These batteries have required information concerning usage as well as information related to the materials of the electrolyte, negative electrode, positive electrode, and battery case recorded using identification patterns on the exterior surface of the battery case in order to identify the many existing types of lithium rechargeable batteries that consist of various material compositions. Therefore, batteries can be classified into batteries that contain substances with serious environment impact or recyclable materials after they are spent and discarded in addition to preventing accidents and problems caused by incorrect usage.

When information is recorded using bar codes and identification patterns on the exterior surface of battery cases as in the batteries disclosed in Japanese Patent Publication No. 11-031485, there are problems in which the information cannot be read if the batteries are packaged for transport and the chance that the information might not be accurately read due to contamination or scratches on spent batteries.

It is also difficult to quickly read recorded information on individual batteries from spent batteries that occur in large quantities and there are also many times when the information cannot be read due to the direction of the batteries.

Furthermore, there is a limit on the amount of information that can be recorded and even though an exterior finish that corresponds to each type of battery in battery products is prepared, it cannot quickly adapt to changes in the recorded details.

### SUMMARY OF THE INVENTION

In view of the foregoing problems described above, an object of the present invention is to provide a classification and collection method as well as an identification method for batteries that makes it easy to identify and classify batteries so as to make it possible to increase the amount of recorded information required to identify as well as classify and sort the batteries along with quickly and stably reading the recorded information.

In order to achieve the above-mentioned objectives, the classification and collection method for a battery according to the invention comprises: writing information related to at least a type of a battery and a material used to an IC tag mounted on the battery; reading required information from the IC tag of a spent battery; classifying the battery into an arbitrary group based on the read information; and performing a predetermined resource recovery processing on each of the classified groups.

According to this classification and collection method, because required information is written to the IC tag mounted to the battery, information is read without being contacted by a reader and there is no chance the information will become unreadable due to scratches or contamination when information is recorded on the exterior surface of the battery. Furthermore, because the amount of recorded information is increased as well as the type of battery and material being used fully distinguished, the classification operation is automated and a large number of batteries efficiently classified. Processes suitable for each battery classified by type are executed making it possible to remove toxic substances and recycle useful materials.

By mounting the IC tag on a specific battery only, this classification and collection method classifies batteries into batteries with the IC tags and batteries without IC tags as well as perform processing identical to non-industrial waste such as dry cell batteries. This method also makes it easy to classify batteries into batteries that contain toxic substances such as rechargeable batteries or batteries that contain substances targeted for recycling.

Preferably, it should not be possible to overwrite the information written in the IC tag. This makes it possible to prevent mistakes from being made in the classification due to overwrites.

Alternatively, entries such as additional information may also be implemented for the information written in the IC tag by allowing conditional overwrites.

In order to achieve the above-mentioned object, the identification method for a battery according to the invention comprises: writing information related to at least a type of a battery and a material used to an IC tag mounted on the battery; reading required information from the IC tag while the battery is located at an arbitrary location; and classifying the battery based on the read information.

According to this identification method, because batteries with restrictions on their transport and handling are detected without being contacted, specific batteries are easily verified during export inspections and the like. Batteries that contain prohibited metals such as radioactive substances and batteries that contain specific toxic chemicals are detected and regulations is added to their transport and handling.

In this identification method it should not be possible to overwrite the information written in the IC tag. This makes it possible to prevent incorrect data from occurring due to overwriting the identification information.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a perspective view showing an exemplary structure of an IC tag to be mounted on a battery; and

FIG. 2 is a block diagram showing the classification and collection process of a battery.

### DESCRIPTION OF THE PREFERRED EMBODIMENTS

A detailed embodiment of the present invention will be hereinafter described with reference to the drawings. The method according to this embodiment include recording information such as the type of battery and the material used to each individual battery and identifying batteries targeted for transportation regulations and usage controls along with classifying spent batteries by type and material used to allow the batteries to be discarded as well as undergo resource recovery. Although the embodiment shown below is one example of the present invention, it does not limit the technical scope of the invention.

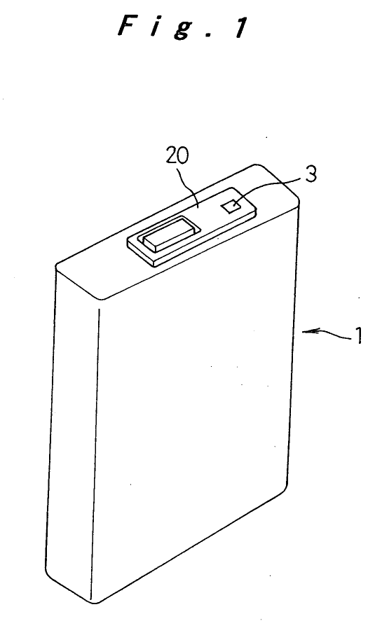

Contamination or scratches might cause battery information such as the type and the material used indicated on the exterior surface of the battery to be unreadable or the amount of information might be insufficient as described above. As shown in the example of FIG. 1, in this embodiment an IC tag 3 is mounted on a specific battery (such as a small rechargeable battery) in the manufacturing stage. The IC tag 3 contains the battery information recorded thereon. Although the battery information recorded onto the IC tag 3 here includes the type of battery, authentication information for authorized products, and information concerning the material used, it goes without saying that the recording details and the recording capacity may be changed as necessary.

It is possible to classify specific batteries equipped with the IC tag 3 into cases in which a battery with transportation regulations and usage controls is identified as well as cases in which collecting and recycling the battery after it is spent is a responsibility. Because either of these cases is identified from the type of battery, information on the type of battery is indispensable as information recorded onto the IC tag 3. Information concerning the material used is also recorded onto the IC tag 3 for the purpose of supplementing the information on the type of battery, specifying the substances targeted for regulations in even more detail, and indicating the type, location where it exists, and content of substances to be collected and recycled.

Since reading and writing information from/to the IC tag 3 are fundamentally performed using electromagnetic waves without contact, any influence passed onto the electromagnetic waves due to metal must be reduced when the outside of the battery is almost entirely covered by metal. For example, an on-chip type IC tag that can be mounted onto metal or an installation construction wherein the IC tag 3 is mounted through an insulator 20 as shown in FIG. 1 are applicable.

A simple classification and collection method will be hereinafter described to sort small rechargeable batteries which must be collected and recycled according to the natural resource effective utilization promotion law into nickel-cadmium rechargeable batteries, nickel metal hydride rechargeable batteries, lithium rechargeable batteries, and small sealed lead-acid rechargeable batteries, classify identical types of rechargeable batteries with different compositions by material used, and then perform resource recovery and recycling.

As shown in the example in FIG. 1, the IC tag 3 is mounted on the small rechargeable battery 1 in the manufacturing stage for small rechargeable batteries which must be collected and recycled according to the natural resource effective utilization promotion law. A tag made up of a passive tag that basically uses a read-only ROM as the storage medium is applicable for the IC tag 3. However, a tag that uses writeable RAM as the storage medium is also applicable as necessary.

Information required to classify and collect the spent batteries is recorded in the IC tag 3 in the manufacturing process of the small rechargeable battery 1. Although examples of the information required to classify and collect the batteries include the type of battery, the manufacturer name, the date of manufacture, the type of trace metals collected, the location where it exists, and content of substances, as well as the existence of noble (precious) metal component, the location where it exists, the type of solvent collected, and the existence of prohibited metals or prohibited chemicals, other required information may also be recorded in response to the storage capacity of the storage medium.

Many of the small rechargeable batteries 1 are incorporated into devices in the form of battery packs, battery units, and board level packaged batteries and are removed as spent batteries when repairing, maintaining, and discarding the devices. Since there are many cases in which removed spent small rechargeable batteries 1 are not classified by battery type, batteries are initially classified by type. In addition, since lithium batteries use different types of materials, it is necessary to classify the batteries by material used. When nickel metal hydride rechargeable batteries (compatible with dry cell batteries) are spent, they are also disposed of using the same route as dry cell batteries. Because of this, it is necessary to classify them from among dry cell batteries. When this classification operation is performed, information is read from the IC tag 3 mounted on the small rechargeable battery 1 and then the classification is performed.

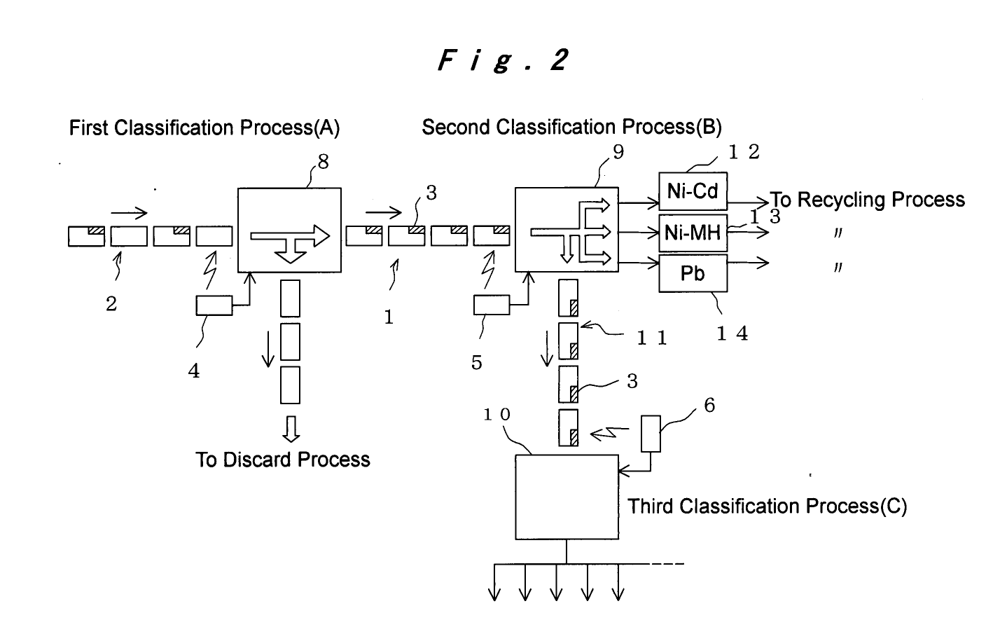

FIG. 2 shows a processing procedure wherein the small rechargeable batteries 1 are sorted from the spent batteries 2, classified by type, and then further classified by material used.

In the first classification process (A) in which the spent batteries 2 are continually transported in one line by a transport unit, such as a belt conveyor, a first reader 4 emits reading radio waves towards the spent batteries 2. Since an IC tag 3 is not mounted to a primary battery (such as a dry cell battery), there is no response to the reading radio wave. In addition, since the IC tag 3 is mounted on the small rechargeable batteries 1, there is a response to the reading radio wave and an acknowledgement radio wave is generated. The first reader 4 transports batteries that responded to the subsequent process as the small rechargeable batteries 1 and then outputs a control signal to a first classification device 8 so as to discharge the other batteries that did not respond towards the discard process.

The spent batteries 2 sorted by the first classification process (A) are transported to a second classification process (B). In the second classification process (B) a second reader 5 emits reading radio waves to the small rechargeable batteries 1 and then receives a response radio wave emitted from the IC tag 3 mounted on each of the small rechargeable batteries 1. Because the response radio wave is modulated by the information recorded in the IC tag 3, the second reader 5 reads the recorded information and outputs a control signal to a second classification device 9 that sorts the small rechargeable batteries 1, based on the recorded information that indicates the types of the small rechargeable batteries 1, into nickel-cadmium rechargeable batteries (Ni—Cd) 12, nickel metal hydride rechargeable batteries (Ni—MH) 13, small sealed lead-acid rechargeable batteries (Pb) 14, and lithium rechargeable batteries (Li) 11. The second classification device 9 sorts the continually transported small rechargeable batteries 1 into separate types in response to control signals from the second reader 5 and then discharges each battery to a corresponding recycling process.

For the nickel-cadmium rechargeable batteries 12, nickel metal hydride rechargeable batteries 13, and small sealed lead-acid rechargeable batteries 14, cadmium, iron, and nickel are collected by a recycling process designed for each battery. Because many different types of materials are used for the lithium rechargeable batteries 11, a third classification process (C) classifies the lithium rechargeable batteries 11 by material used.

In the third classification process (C), a third reader 6 emits reading radio waves towards the lithium rechargeable batteries 11 and then receives a response radio wave from the IC tag 3 mounted on the lithium rechargeable batteries 11. The third reader 6 reads the recorded information of the IC tag 3 from the response radio wave and then classifies the lithium rechargeable batteries 11, based on the used material information, into cobalt-based lithium ion rechargeable batteries, nickel-based lithium ion rechargeable batteries, manganese-based lithium ion rechargeable batteries, lithium ion polymer rechargeable batteries, polyaniline lithium rechargeable batteries, and vanadium lithium rechargeable batteries. The lithium rechargeable batteries classified by material used are transported to recycling processes that correspond to respective types.

In the classification and collection process described above, although the classification process consists of three levels, one classification process also sorts the small rechargeable batteries 1 from the spent batteries 2, classifies the small rechargeable batteries 1 by type, and then classifies the lithium rechargeable batteries 11 by material used.

In the classification and collection process described above, although an example was described focusing on small rechargeable batteries, there are many lithium batteries formed as primary batteries and they also contain useful metals and toxic substances. Therefore, a similar classification process by using IC tags 3 mounted on batteries classifies these batteries into graphite fluoride lithium batteries, manganese dioxide lithium batteries, thionyl chloride lithium batteries, and copper oxide lithium batteries, and then performs collection and recycling as well as suitable processing toxic substances.

Some batteries employ silver as an essential material such as silver oxide batteries or silver oxide zinc rechargeable batteries for use as alkaline batteries, and are targets for classifications as well as collection and recycling in a similar manner with an objective of collecting useful metals.

According to the present invention as described above, the type of battery and materials used are determined based on information written into IC tags mounted on the batteries. Because of this, the identification and classification operations for batteries are automated. Therefore, it is easy to recognize batteries with restrictions on their transport and handling and it is possible to efficiently classify spent batteries by type and material used. A process suitable to each battery is also performed to remove toxic substances and recycle useful materials.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A classification and collection method for a battery, comprising:
writing information related to at least a type of a battery and a material used to an IC tag mounted on the battery;
reading required information from the IC tag of a spent battery;
classifying the battery into an arbitrary group based on the read information; and
performing a predetermined resource recovery processing on each of the classified groups.

2. The classification and collection method for a battery according to claim 1, wherein the IC tag is mounted on a specific battery to classify the battery into the battery with the IC tag and a battery without the IC tag.

3. The classification and collection method for a battery according to claim 1, wherein the information written in the IC tag cannot be overwritten.

4. The classification and collection method for a battery according to claim 1, wherein the information written in the IC tag can be overwritten under a certain condition.

5. An identification method for a battery, comprising:
writing information related to at least a type of a battery and a material used to an IC tag mounted on the battery;
reading required information from the IC tag while the battery is located at an arbitrary location; and
classifying the battery based on the read information.

6. The identification method for a battery according to claim 5, wherein the information written in the IC tag cannot be overwritten.
